(19) United States
(12) Patent Application Publication
(10) Pub. No.: US 2008/0033327 A1
(43) Pub. Date: Feb. 7, 2008

(54) Vibrating apparatuses configured to support the body of a person, vibrating furniture covers, and methods of assembling frameless articles of furniture

(76) Inventors: Zachary L. Evans, Sandy, UT (US); Samuel R. Cowley, Guangzhou (CN)

Correspondence Address: TRASK BRITT, P.O. BOX 2550, SALT LAKE CITY, UT, 84110, US

(21) Appl. No.: 11/499,895

(22) Filed: Aug. 4, 2006

(51) Int. Cl. A61H 1/00

(52) U.S. Cl. 601/57; 601/56

(57) ABSTRACT

Apparatuses for supporting at least a portion of the body of a person include a flexible outer enclosure at least partially filled with particulate material. A first major surface of a cushion is disposed adjacent at least a portion of an interior surface of the outer enclosure. At least one vibration-generating device is disposed adjacent a second major surface of the cushion. Furniture covers configured to cover at least a portion of an article of furniture include a flexible outer enclosure, a cushion disposed at least a portion of an interior surface of the outer enclosure, and at least one vibration-generating device disposed adjacent the cushion. Methods for assembling a frameless article of furniture include positioning at least one vibration-generating device adjacent a cushion, positioning the cushion adjacent an interior surface of a flexible outer enclosure, and inserting particulate material into an interior region of the flexible outer enclosure.

### BACKGROUND OF THE INVENTION

Field of the Invention. The present invention relates to vibrating furniture, and in particular, to chairs, couches, mattresses, pillows, and any other type of furniture that includes a vibration device or system that transmits vibrations to the body of a person supported on such furniture. Such furniture may be used, for example, to provide a relaxing or a therapeutic vibrational massage to the body of a person. The present invention also relates to removable furniture covers, and in particular, to removable furniture covers that include at least one vibration-generating device. The present invention also relates to methods of assembling frameless articles of furniture.

Discussion of Related Art. Vibrating furniture including, for example, chairs, couches, and mattresses have been disclosed in the art. Recently, there have been attempts to design frameless particle-filled furniture that include vibration-generating devices. These attempts have been met with limited success due, at least in part, to difficulties associated with securing the vibration-generating devices at desired locations within the frameless furniture and ensuring that vibrations of sufficient amplitude are uniformly transmitted to the body of a user, all while retaining the overall “feel” of the frameless particle-filled furniture. Such difficulties typically are exacerbated in frameless furniture due to the inability to mechanically couple vibration-generating devices to a frame or other rigid structure.

U.S. Pat. No. 5,007,410 to DeLaney discloses a vibrating mattress. The vibrating mattress includes vibration-generating devices disposed between top and bottom resilient foam rubber layers.

U.S. Pat. No. 5,807,287 to Cheng discloses an elongated vibrating massage pad for supporting the body of a user. The vibrating massage pad includes a plurality of vibration-generating devices disposed in receptacles in or on the pad.

U.S. Pat. No. 6,024,407 to Eakin discloses frameless particle-filled furniture that includes an outer enclosure of supple material, loose material disposed within the outer enclosure, and vibration means for causing the loose material to vibrate. The vibration of the loose material allegedly causes an overall vibration of the frameless particle-filled furniture. The vibration means may include a vibration-generating device that may be simply disposed within the outer enclosure of supple material, or the vibration-generating device may be attached to the outer enclosure of supple material. The frameless particle-filled furniture also includes control means that can be used to selectively activate and deactivate the vibration of the frameless particle-filled furniture.

U.S. Pat. No. 6,206,475 to Tai discloses a frameless inflatable couch or chair. Vibration-generating massage devices are mounted on inner surfaces of the seat surface and the back surface of the inflatable couch or chair.

### BRIEF SUMMARY OF THE INVENTION

The features, advantages, and alternative aspects of the present invention will be apparent to those skilled in the art from a consideration of the following detailed description taken in combination with the accompanying drawings.

In one aspect, the present invention includes vibrating furniture apparatuses that are configured to support at least a portion of the body of a person. Such apparatuses may include a flexible outer enclosure, a cushion disposed adjacent an interior surface of at least a portion of the flexible outer enclosure, and at least one vibration-generating device disposed adjacent the cushion on a side thereof opposite the flexible outer enclosure. In some embodiments, the cushion may have a thickness of between about 0.5 centimeters and about 5.0 centimeters.

In another aspect, the present invention includes removable furniture covers that include a vibration-generating device. Such furniture covers may include a flexible outer enclosure, a cushion disposed adjacent an interior surface of at least a portion of the flexible outer enclosure, and at least one vibration-generating device disposed adjacent the cushion on a side thereof opposite the flexible outer enclosure. In some embodiments, the cushion may have a thickness of between about 0.5 centimeters and about 5.0 centimeters.

In yet another aspect, the present invention includes a method of assembling a frameless article of furniture. Such methods include providing a cushion and at least one vibration-generating device, positioning the vibration-generating device adjacent a major surface of the cushion, and positioning another major surface of the cushion adjacent an interior surface of a flexible outer enclosure. Particulate material may be inserted into an interior region of the flexible outer enclosure, and the flexible outer enclosure may be closed using means for selectively opening and closing the flexible outer enclosure.

### BRIEF DESCRIPTION OF THE DRAWINGS

While the specification concludes with claims particularly pointing out and distinctly claiming that which is regarded as the present invention, the advantages of this invention can be more readily ascertained from the following description of the invention when read in conjunction with the accompanying drawings in which:

FIG. 1 is a perspective view of an apparatus that is configured to support at least a portion of the body of a person and that embodies various teachings of the present invention;

FIG. 2 is a partial cross-sectional view of the apparatus shown in FIG. 1;

FIG. 3 is an enlarged cross-sectional view of a vibration-generating device shown in FIG. 2;

FIG. 4 is an enlarged view of a cushion shown in FIG. 2 illustrating the thickness thereof in accordance with one embodiment thereof;

FIG. 5 is a plan view of the cushion shown in FIGS. 2 illustrating one embodiment having plurality of vibration-generating devices located in an array across a surface of the cushion;

FIG. 6 is a partial cross-sectional view like that of FIG. 2 illustrating another apparatus that that is configured to support at least a portion of the body of a person and that embodies various teachings of the present invention;

FIG. 7 is an enlarged perspective view of a vibration-generating device shown in FIG. 6;

FIG. 8 is a perspective view of an vibrating mattress that is configured to support at least a portion of the body of a person and that embodies various teachings of the present invention; and

FIG. 9 is a perspective view of a vibrating couch that is configured to support at least a portion of the body of a person and that embodies various teachings of the present invention.

### DETAILED DESCRIPTION OF THE ILLUSTRATED EMBODIMENTS

In the description which follows, like features and elements have been identified by the same or similar reference numerals for ease of identification and enhanced understanding of the disclosure hereof. Such identification is by way of convenience for the reader only, however, and is not limiting of the present invention or an implication that features and elements of various components and embodiments identified by like reference numerals are identical or constrained to identical functions.

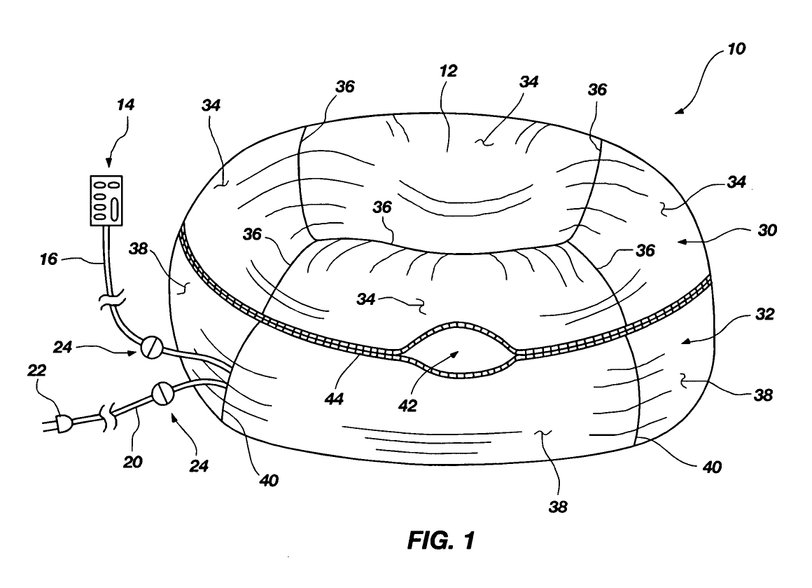

A vibrating furniture apparatus 10 that is configured to support at least a portion of the body of a person and that embodies teachings of the present invention is shown in FIG. 1. The vibrating furniture apparatus 10 shown in FIG. 1 is configured as a frameless chair that includes a flexible outer enclosure 12, which is at least partially filled with particulate material (not shown in FIG. 1). As will be described in further detail below, the vibrating furniture apparatus 10 also may include a plurality of vibration-generating devices disposed within the flexible outer enclosure 12.

In additional embodiments of the present invention, the vibrating furniture apparatus 10 may be configured as a frameless couch, a frameless mattress, a frameless pillow, or any other frameless article of furniture that is configured to support at least a portion of the body of a person.

The vibrating furniture apparatus 10 may include a controller device 14 that is configured to selectively control the vibration-generating devices that are disposed within the flexible outer enclosure 12. The vibrating furniture apparatus 10 also includes means for supplying power to the vibration-generating devices that are disposed within the flexible outer enclosure 12. By way of example and not limitation, the vibrating furniture apparatus 10 may include a power cord 20 that extends from the plurality of vibration-generating devices within the flexible outer enclosure 12 out through the flexible outer enclosure 12 to a power plug located on the exterior of the outer flexible enclosure 12.

As shown in FIG. 1, in some embodiments of the present invention, the outer flexible enclosure 12 of the vibrating furniture apparatus 10 may include a first portion 30 and a second portion 32. The first portion 30 may include a first plurality of individual panels 34 that have been joined together along seams 36. Similarly, the second portion 32 may include a second plurality of individual panels 38 that have been joined together along seams 40. In some embodiments, an opening 42 may be provided in the flexible outer enclosure 12. For example, the opening 42 may be provided between the first portion 30 of the flexible outer enclosure 12 and the second portion 32 of the flexible outer enclosure 12. Optionally, a zipper 43 may be used to selectively open and close the opening 42 in the flexible outer enclosure 12. In additional embodiments, buttons and corresponding button holes, lace, hook and loop material (such as that sold under the trademark VELCRO by Velcro USA Incorporated of Manchester, N.H.), or any other means for selectively opening and closing the opening 42 may be used instead of, or in addition to, the zipper 44.

The size and shape of each of the first plurality of individual panels 34 and the second plurality of individual panels 38 may be selectively configured such that when the first panels 34 are joined along their respective seams 36, the second panels 38 are joined along their respective seams 40, and the hole 42 is shut by the zipper 44, the first plurality of individual panels 34 and the second plurality of individual panels 38 are coupled together to form an enclosure. The enclosure formed by the panels 34, 38 of the outer flexible enclosure 12 may have a generally spherical shape, an elongated oval shape, a rectangular shape or any other shape without limitation.

By way of example, the panels 34 and the panels 38 of the flexible outer enclosure 12 may include a woven fabric material of natural (e.g., cotton) or synthetic (e.g., nylon) fibers or threads. In additional embodiments, the outer enclosure 12 may include leather, or a substantially continuous layer of a polymer material.

It is not necessary to the present invention that the flexible outer enclosure 12 include a first portion 30 and a second portion 32, each including a plurality of adjoined individual panels. In additional embodiments, the flexible outer enclosure 12 may include a single panel of material that is shaped and configured so as to form the flexible outer enclosure 12.

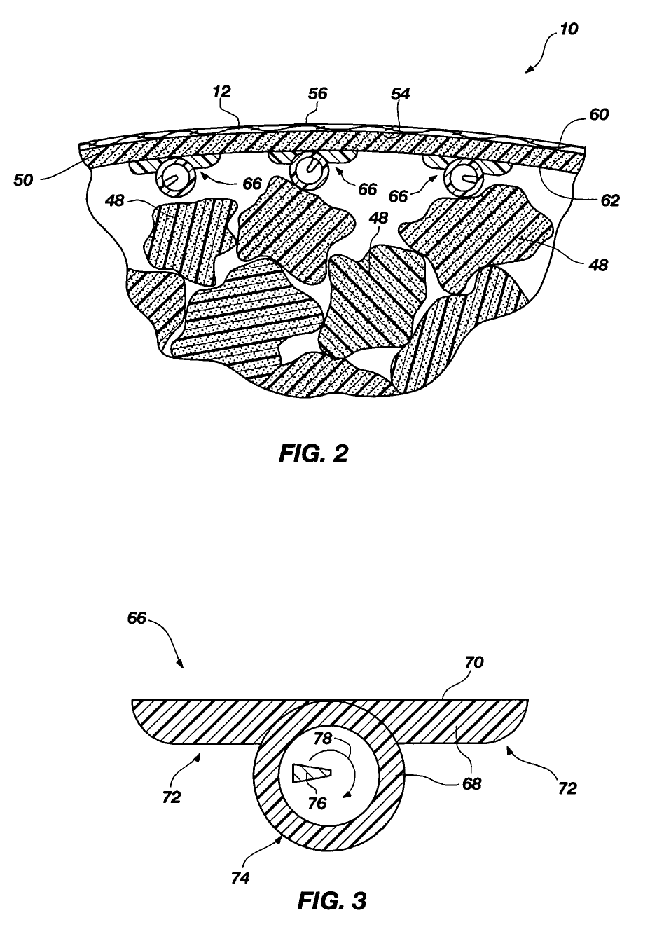

FIG. 2 is a partial cross-sectional view of the vibrating furniture apparatus 10 shown in FIG. 1. As shown in FIG. 2, particulate material 48 may be disposed inside the vibrating furniture apparatus 10. In some embodiments of the present invention, the flexible outer enclosure 12 may be at least partially filled by the particulate material 48. In other embodiments, the flexible outer enclosure 12 may be substantially filled by the particulate material 48. By way of example and not limitation, the particulate material 48 may include shredded foam. Such shredded foam may include what is referred to in the art as memory foam. Such memory foam may include a porous polymer material, such as, for example, polyethylene polyol. In additional embodiments, the particulate material 48 may include a polyurethane foam. The shredded foam may have a density in a range extending from about 13 kilograms per cubic meter (Kg/m³) to about 40 kilograms per cubic meter (Kg/m³). More particularly, the shredded foam may have a density in a range extending from about 13 kilograms per cubic meter (Kg/m³) to about 25 kilograms per cubic meter (Kg/m³).

In yet additional embodiments, the particulate material 48 may include material other than shredded foam, such as, for example, small particles or pellets of natural or synthetic material like those used in conventional “bean bag” type furniture.

As shown in FIG. 2, the vibrating furniture apparatus 10 may include a cushion 50 disposed inside the flexible outer enclosure 12 and adjacent at least a portion of an interior surface 54 of the flexible outer enclosure 12. For example, a first major surface 60 of the cushion 50 may be disposed adjacent a portion of the interior surface 54 of the flexible outer enclosure 12. A plurality of vibration-generating devices 66 also may be disposed inside the flexible outer enclosure 12, and each may be disposed adjacent a second major surface 62 of the cushion 50 on a side thereof opposite the flexible outer enclosure 12. The cushion 50 may have a size, shape, material composition, and density configured to generally evenly transmit vibrations generated by the plurality of vibration-generating devices 66 to the portion of the body of a person that is resting on a region of the exterior surface 56 of the flexible outer cover 12 that overlies the cushion 50.

FIG. 3 is an enlarged cross-sectional view of one vibration-generating device 66 of the plurality of vibration-generating devices 66 shown in FIG. 2. As shown in FIG. 3, each vibration-generating device may include a substantially rigid outer housing 68. In some embodiments, the substantially rigid outer housing 68 may include a plastic material such as, for example, a polypropylene-based material, a polyethylene terephthalate-based material, a polyvinyl chloride-based material, an acrylonitrile butadiene styrene-based material, a polyethylene-based material, or a polyurethane-based material. An exterior surface 70 of the outer housing 68 may be configured to rest against the second major surface 62 of the cushion 50 (FIG. 2).

In one embodiment, the outer housing 68 may include wing portions 72 that are configured to facilitate attachment of the vibration-generating device 66 to the cushion 50. For example, stitching or thread may be used to sew or otherwise secure the wing portions 72 of the outer housings 68 to the cushion. The wing portions 72 optionally may include pre-formed apertures extending therethrough that are configured to receiving such stitching or thread. In additional embodiments, the vibration-generating device 66 may be attached to the cushion 50 using an adhesive such as glue or double-sided adhesive tape. For example, glue or double-sided adhesive tape may be applied to at least one of the exterior surface 70 and the adjacent region on the interior surface 54 of the cushion 50 to which the vibration-generating device 66 is to be attached.

The outer housing 68 may further include a transducer housing portion 74 that is configured to enclose a transducer for converting electrical energy to mechanical vibrational energy. By way of example and not limitation, the transducer housing portion 74 may be configured to enclose an electrical motor (not shown), which may be coupled to a weight member 76 by way of a shaft (not shown). The weight member 76 may be configured such that the center of mass of the weight member 76 is not aligned with the axis of the shaft (not shown). In this configuration, the motor may be configured to spin the shaft and the weight member 76 attached thereto using electrical energy to provide an orbital mass vibrator. As the weight member 76 is spun around within the transducer housing portion 74 in the direction indicated by the arrow 78, vibrations may be generated because the center of mass of the weight member 76 is not aligned with the rotational axis of the rotating shaft (not shown). These vibrations may be transmitted through the outer housing 68 to the cushion 50 (FIG. 2) by way of the exterior surface 70 of the outer housing 68.

Referring again to FIG. 2, it may be desirable to provide the cushion 50 between the flexible outer enclosure 12 and the vibration-generating devices 66 so as to both dampen intense vibrations generated by the vibration-generating devices 66, which might otherwise be uncomfortable to a person if the vibration-generating devices 66 are disposed immediately adjacent the outer flexible enclosure 12 and the body of a person supported thereon. Furthermore, the cushion 50 may facilitate transmission of vibrations generated by the vibration-generating devices 66 in the lateral directions relative to the cushion 50 (i.e., parallel to the first major surface 60 and the second major surface 62 of the cushion 50). In so doing, a person whose body is at least partially supported by the vibrating furniture apparatus 10 over the cushion 50 may perceive the vibrations generated by the vibration-generating devices 66 to emanate generally evenly from the entire cushion 50, as opposed to localized vibrations in the immediate regions surrounding each vibration-generating device 66. As a result, it may be necessary or desirable to configure the size, shape, material composition, and density of the cushion 50 to optimize or maximize the transmission of the vibrations generated by the plurality of vibration-generating devices 66 in the lateral direction, while at the same time, optimizing the level of vibration damping effectuated by the cushion 50 in the region immediately surrounding each vibration-generating device 66.

Furthermore, since the vibrating furniture apparatus 10 may be configured as a frameless particle-filled article of furniture (e.g., chair, couch, mattress, pillow, etc.), as previously described, it may be necessary or desirable to configure the size, shape, material composition, and density of the cushion 50 so as to minimally alter the affect to the overall “feel” of the frameless particle-filled article of furniture. In other words, it may be necessary or desirable to configure the cushion 50 so as not to significantly alter the perception of a person using the vibrating furniture apparatus 10 that the vibrating furniture apparatus 10 is filled with the particulate material 48. If the cushion 50 is too thick, too rigid, or both too thick and too rigid, the vibrating furniture apparatus 10 may not feel like a more conventional frameless particle-filled article of furniture to a person whose body is resting on the vibrating furniture apparatus 10.

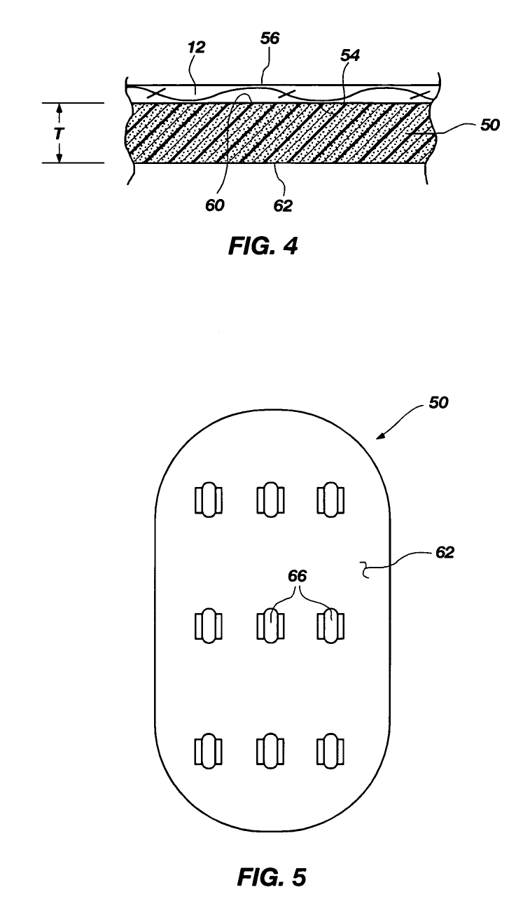

Referring to FIG. 4, in some embodiments of the present invention, the cushion 50 may have a generally uniform thickness T in a range extending from about 0.5 centimeters to about 5.0 centimeters. More particularly, the cushion 50 may have a generally uniform thickness T in a range extending from about 0.5 centimeters to about 2.0 centimeters. The cushion 50 may include a polymer material such as, for example, a polyurethane-based material or a polyethylene-based material. Furthermore, the cushion may include a polymeric foam material, and the polymeric foam material optionally may be a polymeric memory foam material. In some embodiments, the cushion 50 may include a material identical to that of the particulate material 46. In other embodiments, the cushion 50 may include one or more materials that are different from that of the particulate material 46. In some embodiments of the present invention, the cushion 50 may have a density in a range extending from about 13 kilograms per cubic meter (Kg/m³) to about 40 kilograms per cubic meter (Kg/m³). More particularly, the cushion 50 may have a density in a range extending from about 13 kilograms per cubic meter (Kg/m³) to about 25 kilograms per cubic meter (Kg/m³).

Optionally, the cushion 50 may have a multilayered structure, each layer of which may be configured to impart one or more selected physical properties or characteristics to the cushion 50. By way of example and not limitation, one layer of such a multilayered cushion 50 may be configured to facilitate transmission of vibrations generated by the vibration-generating devices 66 in the lateral directions relative to the cushion 50, and another layer of such a multilayered cushion 50 may be configured to dampen the vibrations generated by the vibration-generating devices 66 at least in the regions immediately surrounding the vibration-generating devices 66.

In some embodiments of the present invention, the vibrating furniture apparatus 10 may include a plurality of vibration-generating devices 66, and the vibration-generating devices 66 may be disposed in a selected array across the cushion 50. FIG. 5 is a plan view of one embodiment of a cushion 50 that may be used in the vibrating furniture apparatus 10 shown in FIGS. 1-2. As shown in FIG. 5, in one embodiment of the present invention set forth merely as an example, nine vibration-generating devices 66 may be disposed in a selected array of three rows and three columns across the second major surface 62 of the cushion 50. It is contemplated that vibrating furniture apparatuses that embody teachings of the present invention may include any number of vibration-generating devices 66, and that such vibration-generating devices 66 may be disposed randomly or in any selected ordered array across the cushion 50.

As can be seen with combined reference to FIGS. 1 and 5, the cushion 50 may be sized and configured to cover only a portion of the interior surface 54 (FIG. 2) of the flexible outer enclosure 12. For example, in one particular embodiment, the cushion 50 may have a substantially elongated shape (as shown in FIG. 5), and the cushion 50 may be positioned adjacent and secured to only one panel 34 of the first portion 30 of the vibrating furniture apparatus 10 (FIG. 1). For example, the cushion 50 may be positioned adjacent and secured to only the upper central panel 34 of the first portion 30 of the vibrating furniture apparatus 10 shown in FIG. 1.

When using frameless particle-filled furniture such as a couch or chair, it may be necessary or desirable to periodically redistribute the particulate material 48 within the frameless particle-filled furniture so as to re-form or “fluff” the furniture to a desired shape. This typically is done by rolling, re-positioning, or otherwise moving the frameless particle-filled article of furniture. As previously discussed herein with reference to FIG. 1, the vibrating furniture apparatus 10 may include a power cord 20 that extends from the plurality of vibration-generating devices within the flexible outer enclosure 12 out through the flexible outer enclosure 12 to a plug located on the exterior of the outer flexible enclosure 12. Furthermore, the vibrating furniture apparatus 10 may include a controller wire 16 that extends from the plurality of vibration-generating devices within the flexible outer enclosure 12 out through the flexible outer enclosure 12 to the controller device 14. As such, one or more wires (such as the power cord 20 and the controller wire 16) may extend out from the flexible outer enclosure 12. Such wires may complicate rolling, re-positioning, or otherwise moving the frameless particle-filled article of furniture so as to re-form or “fluff” the furniture to a desired shape. In order to facilitate such rolling, re-positioning, or moving of the vibrating furniture apparatus 10, a detachable coupling 24 may be provided along at least one of the controller wire 16 and the power cord 20 generally proximate the exterior surface 56 of the flexible outer enclosure 12, as shown in FIG. 1. By way of example and not limitation, each detachable coupling 24 may include complementary male and female connectors that can be selectively connected and de-connected. In this configuration, the male and female connectors may be selectively de-connected prior to rolling, re-positioning, or otherwise moving the vibrating furniture apparatus 10. The male and female connectors then may be re-connected to use the vibrating furniture apparatus 10. Furthermore, the detachable couplings 24 may serve as a safety device to prevent damage to one or more of the power cord 20, power plug 22, controller wire 16, and the controller device 14 when the frameless particle-filled article of furniture is moved to fluff furniture to a desired shape.

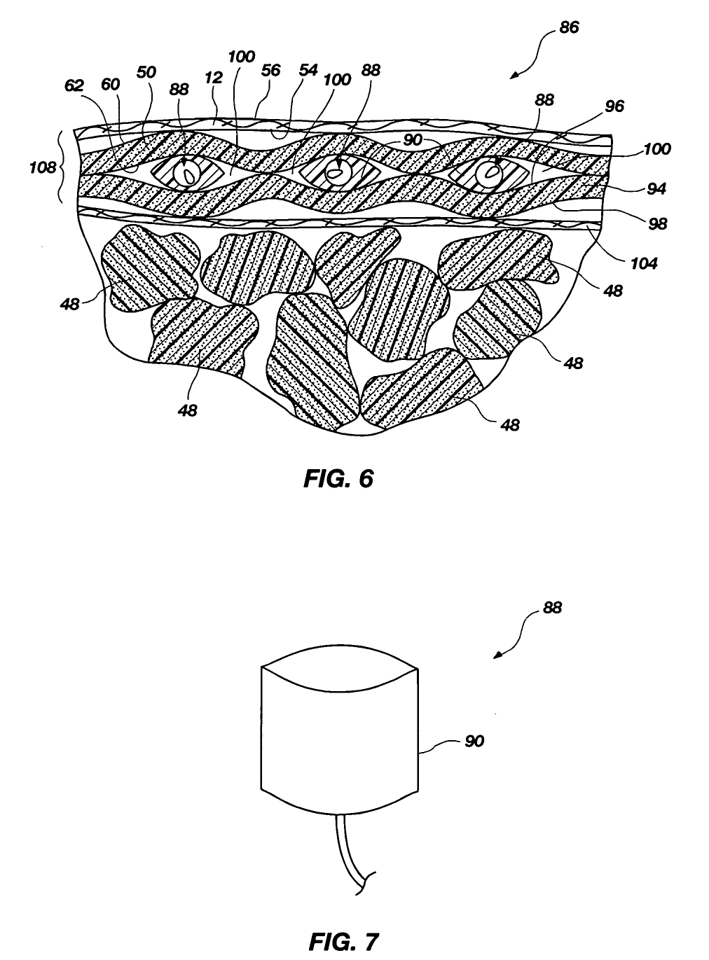

A partial cross-sectional view (like that shown in FIG. 2) of another vibrating furniture apparatus 86 that is configured to support at least a portion of the body of a person and that embodies teachings of the present invention, is shown in FIG. 6. As shown therein, the vibrating furniture apparatus 86 may include a flexible outer enclosure 12 having an exterior surface 56 and an interior surface 54, and a cushion 50 having a first major surface 60 and a second major surface 62, as previously described herein. The vibrating furniture apparatus 86 may also include a plurality of vibration-generating devices 88. The vibration-generating devices 88 may be generally similar to the vibration-generating devices 66 previously described herein, with the exception of the outer housing 90 of the vibration-generating devices 88 exhibiting a different geometrical configuration.

FIG. 7 is an enlarged perspective view of a vibration-generating device 88 like those shown in FIG. 6. As shown in FIG. 6 and FIG. 7, the outer housing 90 may have a generally oval, elliptical, or other cross-sectional shape. In this configuration, one side of the outer housing 90 may be configured to be disposed adjacent the second major surface 62 of the cushion 50, and an opposite side of the outer housing 90 may be configured to be disposed adjacent a first major surface 96 of an additional cushion 94, which is shown in FIG. 6. In this configuration, each vibration-generating device 88 may be disposed or sandwiched between the cushion 50 and the additional cushion 94.

In some embodiments of the present invention, the additional cushion 94 may have a material composition that is substantially similar to the cushion 50. Furthermore, the additional cushion 94 may have a size and shape that is substantially similar to the cushion 50. In additional embodiments, the additional cushion 94 may differ from the cushion 50 in one or more aspect. For example, the material composition of the additional cushion 94 may differ from the material composition of the cushion 50. Furthermore, the thickness of the additional cushion 94 may differ from the thickness of the cushion 50.

To secure the vibration-generating devices 88 between the cushion 50 and the additional cushion 94, in some embodiments, the exterior surface of one side of the outer housing 90 may be attached to the second major surface 62 of the cushion 50 using glue or double-sided adhesive tape, and the exterior surface of the opposite side of the outer housing 90 may be attached to the first major surface 96 of the additional cushion 94 using glue or double-sided adhesive tape. In addition or as an alternative, the cushion 50 may be attached to the additional cushion 94 (by, for example, sewing, stitching, or using an adhesive) between the vibration-generating devices 88, or around at least a portion of each vibration-generating device 88. In such a configuration, a plurality of pockets 100 may be formed between the cushion 50 and the additional cushion 94, in each of which may be disposed a vibration-generating device 88. These pockets 100 may operate to maintain the vibration-generating devices 88 at selected locations between the cushion 50 and the additional cushion 94 and effectively provide a single cushion having the vibration-generating devices 88 embedded therein.

As shown in FIG. 6, in some embodiments of the present invention, the vibrating furniture apparatus 86 (or the vibrating furniture apparatus 10 shown in FIG. 1) may include a flexible inner liner 104. The flexible inner liner 104 may be configured to enclose the particulate material 48, and may be similar to the outer flexible enclosure 12. The flexible inner liner 104 also may include an opening that is substantially similar to the opening 42 provided in the outer flexible enclosure 12, as previously described with reference to FIG. 1. In such a configuration, the outer flexible outer enclosure 12, the cushion 50, the vibration-generating devices 88, and the additional cushion 94 may be part of a removable vibrating furniture cover 108.

In view of the above, removable vibrating furniture covers (such as the removable vibrating furniture cover 108 shown in FIG. 6) that are configured to at least partially cover an article of furniture, and in particular, a frameless particle-filled article of furniture, may embody teachings of the present invention. For example, a removable vibrating furniture cover 108 that is configured to cover a frameless particle-filled chair may include a flexible outer enclosure 12, a cushion 50 attached to an interior surface 54 of the flexible outer enclosure 12, and at least one vibration-generating device (such as, for example, a vibration-generating device 66 or a vibration-generating device 88 as previously described) attached to the cushion 50 on a side thereof opposite the flexible outer enclosure. Optionally, the removable vibrating furniture cover may include a plurality of vibration-generating devices, and the vibration-generating devices may be disposed between the cushion 50 and an additional cushion 94, as shown in FIG. 6. Referring to FIG. 1, the flexible outer enclosure 12 may include an opening 42 that is configured to facilitate placement of the flexible outer enclosure 12 over at least a portion of an article of furniture. Furthermore, the flexible outer enclosure 12 may also include means for selectively substantially closing the opening 42 in the flexible outer enclosure 12 (such as, for example, a zipper, lace, buttons, hook and loop material, etc.)

While the removable vibrating furniture cover 108 shown in FIG. 6 is configured to substantially entirely cover or otherwise define a frameless particle-filled chair, it is contemplated that in additional embodiments, the removable vibrating furniture cover 108 may be configured to cover at least a portion of any couch, chair, mattress, pillow, or any other article of furniture configured to support at least a portion of the body of a person. Such article of furniture may include a rigid frame, may not include a rigid frame, and may or may not include a particulate material (such as the particulate material 48 previously described herein).

An example of a method that embodies teachings of the present invention and that may be used to assemble a frameless article of furniture that is configured to support at least a portion of the body of a person is now described with reference to FIGS. 1-2. According to one method, a cushion 50 may be provided having a first major surface 60 and a second major surface 62. As previously described herein with reference to FIG. 6, the cushion 50 may have a generally uniform thickness T in a range from about 0.5 centimeters to about 5.0 centimeters. At least one vibration-generating device 66 may be provided and positioned adjacent the second major surface of the cushion 50. Optionally, the vibration-generating device 66 may be attached to the cushion 50, as previously described herein. Furthermore, if necessary or desired, an additional cushion 94 may be provided over the vibration-generating device 66, as also previously described. A flexible outer enclosure 12 may be provided, and the cushion 50 may be positioned adjacent at least a portion of the interior surface 54 of the flexible outer enclosure 12. Optionally, the cushion 50 may be attached to the cushion 50 by sewing, stitching, or using an adhesive material. Particulate material 48 may be provided within the flexible outer enclosure 12 through the opening 42 (FIG. 1), and the flexible outer enclosure 12 may be closed using a zipper, buttons, lace, hook and loop material, or any other means for selectively opening and closing the flexible outer enclosure 12.

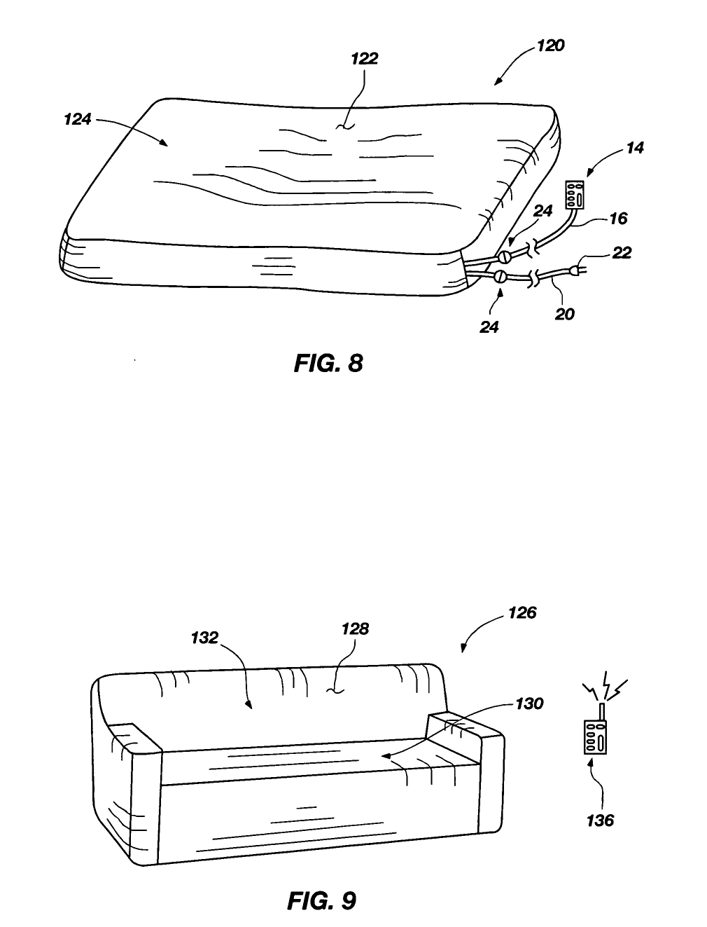

As previously mentioned, it is contemplated that vibrating furniture apparatuses that embody teachings of the present invention may include articles of furniture other than frameless particulate-filled chairs. For example, a mattress 120 that may embody teachings of the present invention is shown in FIG. 8. The mattress 120 may include a flexible outer enclosure 122, which may be substantially similar to the outer flexible enclosure 12 previously described in relation to FIGS. 1-2. The mattress 120 may also include a cushion 50 (FIG. 2) and a plurality of vibration-generating devices (such as the vibration-generating devices 66 or the vibration-generating devices 88) disposed adjacent the cushion 50 on a side thereof opposite the flexible outer enclosure 122. By way of example and not limitation, the cushion 50 and the vibration generating-devices may be disposed adjacent the upper resting surface 124 of the mattress 120. In some embodiments, the mattress 120 may be a frameless particle-filled mattress, and may include particulate material 48 as previously described herein.

Similarly, FIG. 9 illustrates a couch 126 that may embody teachings of the present invention. The couch 126 may include a flexible outer enclosure 128, which may be substantially similar to the outer flexible enclosure 12 previously described in relation to FIGS. 1-2. The couch 126 may also include a cushion 50 (FIG. 2) and a plurality of vibration-generating devices (such as the vibration-generating devices 66 or the vibration-generating devices 88) disposed adjacent the cushion 50 on a side thereof opposite the flexible outer enclosure 128. By way of example and not limitation, the cushion 50 and the vibration generating-devices may be disposed adjacent one or both of the seat support surface 130 and the back support surface 132 of the couch 126. In some embodiments, the couch 126 may be a frameless particle-filled couch, and may include particulate material 48 as previously described herein.

Furthermore, removable vibrating furniture covers (similar to the removable vibrating furniture cover 108 previously described in relation to FIG. 6) that embody teachings of the present invention may have a size and shape configured to cover a mattress, such as the mattress 120 shown in FIG. 8, or a size and shape configured to cover a couch, such as the couch 126 shown in FIG. 9. Furthermore, such removable vibrating furniture covers may have a size and shape configured to cover or encompass at least a majority of an article of furniture, such as, for example a chair, a mattress, or a couch, and may have a size and shape configured to entirely cover or enclose such an article of furniture.

The present invention provides vibrating furniture apparatuses that may be used to provide therapeutic and relaxing vibratory massages evenly and comfortably to the body of a person supported thereon. Furthermore, the present invention provides frameless particle filled vibrating furniture apparatuses for providing such vibratory massages to the body of a person supported thereon. Removable vibrating furniture covers may also be provided that embody teachings of the present invention, and such removable vibrating furniture covers also may be used together with preexisting or separately fabricated furniture for providing such vibratory massages to the body of a person supported thereon.

As previously discussed herein, the vibration-generating apparatuses 66 and the vibration-generating apparatuses 88 may be selectively controlled using a controller device 14, such as that shown in FIG. 8. It is contemplated that the vibration-generating apparatuses 66 and 88 may be selectively controlled using a remotely operated controller device 136, as shown in FIG. 9. The remotely operated controller device 136 may be configured to selectively control vibration-generating apparatuses within the couch 126 (not shown in FIG. 9) using signals transmitted between the remotely operated controller device 136 and the vibration-generating apparatuses via electromagnetic radiation (e.g., radio signals, infrared signals, etc.).

Furthermore, the vibration-generating apparatuses 66 and 88 may be supplied with electrical power from a pre-existing power grid structure by way of a power cord 20 and a plug 22 configured to be received within a power socket (not shown) of the pre-existing power grid, as shown in FIG. 8. It is contemplated that the vibration-generating apparatuses 66 and 88 may be supplied with electrical power from a battery (replaceable or rechargeable), which may be disposed internally within the vibrating furniture apparatus in which the vibration-generating apparatuses 66 or 88 are disposed. For example, the vibration-generating apparatuses of the couch 126 shown in FIG. 9 may operate using electrical power supplied from a battery (not shown) disposed within the couch 126.

While the present invention has been described in terms of certain illustrated embodiments and variations thereof, it will be understood and appreciated by those of ordinary skill in the art that the invention is not so limited. Rather, additions, deletions and modifications to the illustrated embodiments may be effected without departing from the spirit and scope of the invention as defined by the claims which follow.

1. An apparatus configured to support at least a portion of the body of a person, the apparatus comprising:
a flexible outer enclosure having an interior surface and an exterior surface;
particulate material disposed within and at least partially filling the flexible outer enclosure;
a cushion having a first major surface, a second major surface, and a thickness between the first major surface and the second major surface of between about 0.5 centimeters and about 5.0 centimeters, the first major surface of the cushion being disposed adjacent at least a portion of the interior surface of the flexible outer enclosure; and
at least one vibration-generating device disposed adjacent the second major surface of the cushion.

2. The apparatus of claim 1, wherein the apparatus comprises a frameless couch, a frameless chair, a frameless mattress, or a frameless pillow.

3. The apparatus of claim 1, wherein the particulate material comprises a resilient polymer material.

4. The apparatus of claim 3, wherein the particulate material comprises shredded foam material.

5. The apparatus of claim 1, further comprising a control device operatively coupled to the at least one vibration-generating device and configured to selectively control the at least one vibration-generating device.

6. The apparatus of claim 5, wherein the control device is configured to selectively control the at least one vibration-generating device by way of electrical signals transmitted wirelessly using electromagnetic radiation.

7. The apparatus of claim 5, further comprising an electrical wire extending between the control device and the at least one vibration-generating device, the electrical wire comprising at least one intermediate coupling disposed along the electrical wire exterior of the flexible outer enclosure.

8. The apparatus of claim 1, further comprising a power cord extending from the at least one vibration-generating device to the exterior of the flexible outer enclosure, the power cord comprising at least one intermediate coupling disposed along the electrical wire exterior of the flexible outer enclosure.

9. The apparatus of claim 1, wherein the cushion is fixedly attached to at least a region of the outer flexible enclosure.

10. The apparatus of claim 9, wherein the at least one vibration-generating device is fixedly attached to the second major surface of the cushion.

11. The apparatus of claim 1, wherein the at least one vibration-generating device comprises a plurality of vibration-generating devices disposed in an ordered array on the second major surface of the cushion.

12. The apparatus of claim 1, further comprising an additional cushion, the additional cushion having a first major surface, a second major surface, and a thickness between the first major surface and the second major surface of between about 0.5 centimeters and about 5.0 centimeters, the at least one vibration-generating device being disposed between the second major surface of the cushion and the first major surface of the additional cushion.

13. The apparatus of claim 12, further comprising a flexible inner liner enclosing the particulate material, the second major surface of the additional cushion being disposed adjacent a surface of the flexible inner liner.

14. A removable furniture cover configured to cover at least a portion of an article of furniture, the apparatus comprising:
a flexible outer enclosure having an interior surface, an exterior surface, and an opening in the flexible outer enclosure configured to facilitate placement of the flexible outer enclosure over at least a portion of an article of furniture;
a cushion having a first major surface, a second major surface, and a thickness between the first major surface and the second major surface of between about 0.5 centimeters and about 5.0 centimeters, the first major surface of the cushion being disposed adjacent at least a portion of the interior surface of the flexible outer enclosure; and
at least one vibration-generating device disposed adjacent the second major surface of the cushion.

15. The furniture cover of claim 14, wherein the flexible outer enclosure has a size and shape configured to cover at least a portion of at least one of a couch, a chair, a mattress, and a pillow.

16. The furniture cover of claim 14, wherein the flexible outer enclosure has a size and shape configured to substantially entirely cover a frameless chair.

17. The furniture cover of claim 14, further comprising means for selectively substantially closing the opening in the flexible outer enclosure.

18. The furniture cover of claim 17, wherein the means for selectively substantially closing the opening in the flexible outer enclosure comprises at least one of a zipper, a button, a lace, and hook-and-loop materials.

19. A method of assembling a frameless article of furniture, the method comprising:
providing a cushion having a first major surface, a second major surface, and a thickness between the first major surface and the second major surface of between about 0.5 centimeters and about 5.0 centimeters;
providing at least one vibration-generating device;
positioning the at least one vibration-generating device adjacent the second major surface of the cushion;
providing a flexible outer enclosure having an interior surface, an exterior surface, an opening in the flexible outer enclosure, and means for selectively opening and closing the flexible outer enclosure;
positioning the first major surface of the cushion adjacent the interior surface of the flexible outer enclosure;
inserting particulate material into an interior region of the flexible outer enclosure; and
closing the flexible outer enclosure using the means for selectively opening and closing the flexible outer enclosure.

20. The method of claim 19, wherein the particulate material comprises a resilient polymer material.

21. The method of claim 19, further comprising:
providing an additional cushion having a first major surface, a second major surface, and a thickness between the first major surface and the second major surface of between about 0.5 centimeters and about 5.0 centimeters; and
positioning the at least one vibration-generating device between the second major surface of the cushion and the first major surface of the additional cushion.

22. The method of claim 19, further comprising securing the at least one vibration-generating device at a selected location on the second major surface of the cushion.
